(19) United States
(12) Patent Application Publication
(10) Pub. No.: US 2013/0198333 A1
(43) Pub. Date: Aug. 1, 2013

(54) METHOD AND DEVICE FOR RECORDING AND REPRODUCING WEB OPERATION

(71) Applicants: Tomohiro Nakamura, Hachioji (JP); Daisuke Tashiro, Yokohama (JP); Tomotaka Shionoya, Yokohama (JP)

(72) Inventors: Tomohiro Nakamura, Hachioji (JP); Daisuke Tashiro, Yokohama (JP); Tomotaka Shionoya, Yokohama (JP)

(73) Assignee: HITACHI, LTD., Chiyoda-ku, Tokyo (JP)

(21) Appl. No.: 13/820,253

(22) PCT Filed: Mar. 9, 2011
(86) PCT No.: PCT/JP2011/055475

§ 371 Date: Apr. 11, 2013

(30) Foreign Application Priority Data
Mar. 8, 2011 (JP) 2011-049862

(51) Int. Cl. H04L 29/08

(52) U.S. Cl. CPC H04L 29/0809
USPC 709/217

(57) ABSTRACT

Web browser operation is reproduced without a server being affected by the web operation. A web browser of a client receives a web page, executes an embedded browser-in-formation-acquiring function module and operation-log-acquiring function, generates a log of operations on the web page and application log of the result of executing an application code, and transmits the logs as a user log, together with information related to the web browser, to a content storage and reproduction server device. The content storage and reproduction server converts the received and gathered content and user log, and generates reproduction content and a reproduction user log for reproducing operation in the web browser of an external reproduction device. The content and user log are converted so that web operation can be safely and accurately reproduced with consideration given to the user environment and to the environment during reproduction when the web operation is reproduced.

### TECHNICAL FIELD

The present invention relates to a technology that records an operation of a web application on a web browser and reproduces a web operation recorded on another web browser.

### BACKGROUND ART

In recent years, as a type of providing a service on various apparatuses, web services using web browsers have increased. Standardization of the web services, such as a basic document configuration, is been in progress, the web services can provide a common service on various apparatuses. Further, in recent years, expressive power has been improved by using a script language, and the like, and as a result, a using range has been expanded. With this, user layers have been extended and usage scenes of the web services become diversified.

From this background, functions or targets required for a user support for a web application or maintenance or improvement have been expanded. Meanwhile, it is difficult for a provider of a web service to implement efficient user support or maintenance and improvement by the diversification of the usage scenes.

In this regard, a method has been considered, in which an operation situation on the web browser is visualized to be used in the user support or the maintenance and improvement. In a method using an access log in which a request of a web page from a user is recorded, which is recordable in a web server as the simplest method, a web page with a lot of requests may be specified or an action by a web page unit for each user may be determined. However, by this simple method, up to operability in a web page which is largely changed by an operating environment such as an apparatus or a web browser which the user is using, or a window size or a set-up of an input device cannot be determined. Therefore, in an actual user support, a method of determining a situation of the user by other methods such as a telephone, an e-mail, chatting, and the like or a method of determining the situation by installing a tool that shares a screen in a client device of the user in some cases and sharing the screen has been adopted. However, since these methods lay a burden such as explanation or an installation operation to the user, the improvement is required.

From the above, a technology, which is easily introduced or used and accurately determines the situations of the users in various using scenes, is required, and in the related art, supported technologies disclosed in Patent Literatures 1 to 5 have been discussed.

### CITATION LIST

### Patent Literature

Patent Literature 1: Japanese Patent Application Laid-Open Publication No. 2010-49294
Patent Literature 2: Japanese Patent Application Laid-Open Publication No. Heill (1999)-353261
Patent Literature 3: Japanese Patent Application Laid-Open Publication No. 2001-337887
Patent Literature 4: Japanese Patent Application Laid-Open Publication No. 2003-36223
Patent Literature 5: Japanese Patent Application Laid-Open Publication No. 2001-60179

### SUMMARY OF INVENTION

### Technical Problem

Patent Literature 1 discloses a method which acquires a snap shot of a web page by inserting a script into the web page and enables searching, but since a situation of a user can be determined only for each snap shot by this method, the snap shot needs to be recorded whenever the user performs the operation in order to determine the details of situation of the user. Further, since the snap shot of the web page is acquired on a client device, a large quantity of communications occur at the time of transmitting the snap shot to a web server device side or an area, which stores a large quantity of data, needs to be prepared in the client device. In particular, in the case where a content of the web page is dynamically changed on a web browser by using a script language, and the like, when the snap shot of the web page is acquired whenever the content is changed, there is a problem in that the number of snap shots becomes large.

Further, Patent Literature 2 discloses a method in which a web server converts a web page into a web page, which is displayable under an environment, according to the environment of a user such as a type of a client or a browser and thereafter, returns the web page, but in the case where a browser used at the time of determining a situation of a user and a user's browser are different from each other, the difference cannot be absorbed by this method.

Further, Patent Literature 3 discloses a method which converts a web page into a web page for a web browser of a cellular phone and thereafter, performs transmission. However, since the web page is not converted according to an operation of the user or a state of a client in this method, the operation cannot be accurately reproduced on a web page.

Further, Patent Literature 4 discloses a method in which a script which does not correspond is displayed by sending a result by, in advance, executing conversion according to a browser that displays a script included in a markup document such as a web page, and the like. However, in the case where an execution result of the script depends on the operation of the user or the state of the client, there is a problem in that the script cannot be accurately executed by this method.

In addition, Patent Literature 5 discloses a method which stores an access history regarding dynamic contents, which are accessible, by setting an operation event and a property of an object of an operation target as a set, by operating a form on a web browser and reproduces a situation of a user by causing a dynamic change by actually executing the operation event. However, there is a problem in which it is impossible to deal with time-dependent contents which cannot be reproduced or an operation which should be actually executed, such as deposit processing, and the like by this method.

An object of the present invention is to provide a method and a device for recording and reproducing a web operation, which can record an operation performed on a web browser of a client and reproduce the recorded operation with high precision on another web browser, based on the aforementioned problems.

Further, an object of the present invention is to provide a method and a device for recording and reproducing a web operation, which is easily introduced and used, and safely implements reproduction of an operation situation with precision to determine a situation of a user without laying a burden to the user.

### Solution to Problem

In order to achieve the above object, in the present invention, there is provided a method for recording and reproducing a web operation in a system constituted by a web server, a web browser displaying a web page, a content storage and reproduction server collecting and storing contents of the web page, and a network coupling them to each other, including: inserting, by the web server, an operation log acquisition function and a browser information acquisition function into the web page and transmits the inserted functions and transmits the contents of the web page to the content storage and reproduction server, at the time of transmitting a generated web page to the web browser, executing, by the web browser, the browser information acquisition function in the received web page, acquires and records information on the web browser, executes the operation log acquisition function, generates and records an application log (application log) of a result of executing an operation log on the web page and an application code include in the web page, and transmits the information on the web browser, the operation log, and the application log to the content storage and reproduction server as a user log, and generating, by the content storage and reproduction server, a reproduction content and a reproduction user log for reproducing an operation on a web browser of an external reproduction device by converting the collected content and user log, and a system therefor.

Further, in order to achieve the above object, in the present invention, there is provided a device for reproducing a web operation that reproduces a web page generated by a web server and displayed by a web browser, the device including: a processing unit; and a storage unit, in which the storage unit stores a content of the web page displayed in the web browser, information on the web browser which the web browser acquires and records by executing a browser information acquisition function, which is collected from the web browser, and a user log constituted by an operation log on the web page which the web browser acquires and records by executing an operation log acquisition function, and an application log of a result of executing an application code included in the web page, and the processing unit generates a reproduction content and a reproduction user log for reproducing an operation on a web browser of an external reproduction device by converting the content and user log stored in the storage unit.

### Advantageous Effects of Invention

According to an aspect of the present invention, a web operation can be reproduced with high precision and safely under various using environments.

### BRIEF DESCRIPTION OF DRAWINGS

FIG. 1 is a configuration diagram of a system of executing a web application according to a first embodiment.

FIG. 2 is a flowchart of recording and reproduction processing of a web operation according to the first embodiment.

FIG. 3A is a diagram illustrating functions of primary units of a content storage and reproduction server device according to the first embodiment.

FIG. 3B is a diagram for describing a side effect removing module in the content storage and reproduction server device according to the first embodiment.

FIG. 3C is a diagram for describing a using environment reflection function module in the content storage and reproduction server device according to the first embodiment.

FIG. 4 is a diagram illustrating an example of a processing flow of converting a content and a user log in the content storage and reproduction server device according to the first embodiment.

FIG. 5 is a processing flowchart of recording and reproducing an operation according to the first embodiment.

FIG. 6 is a processing flowchart of converting a content and a user log according to a second embodiment.

FIG. 7A is a diagram for describing an example in which a problem occurs at the time of reproducing an operation according to a third embodiment.

FIG. 7B is a diagram for describing an example in which a problem occurs at the time of reproducing an operation according to the third embodiment.

FIG. 8 is a processing flowchart of converting a content and a user log according to the third embodiment.

FIG. 9A is a diagram for describing an example in which a problem occurs at the time of reproducing an operation according to a fourth embodiment.

FIG. 9B is a diagram for describing an example in which a problem occurs at the time of reproducing an operation according to the fourth embodiment.

FIG. 10 is a processing flowchart of converting a content and a user log according to a fifth embodiment.

FIG. 11 is a diagram illustrating an example of reproducing a web operation according to the fifth embodiment.

FIG. 12 is a processing flowchart of converting a content and a user log according to the fifth embodiment.

FIG. 13 is a processing flowchart of converting a content and a user log according to a sixth embodiment.

FIG. 14 is a processing flowchart of converting a content and a user log according to the sixth embodiment.

FIG. 15 is a diagram illustrating an example of reproducing a web operation according to a seventh embodiment.

### DESCRIPTION OF EMBODIMENTS

In a method and a device for recording and reproducing a web operation on a web browser according to the present invention, in a web server where a web application is operated, an operation on the web browser is recorded on a client as an operation log in a web page and it is determined whether a request from the outside is made, and a function to transmit the operation log recorded according to the request is inserted. In this case, the web server stores the web page generated by the web application as a content and further, grants a unique value to the web page and stores the web page granted with the unique value in the content storage and reproduction server as an identifier. The content storage and reproduction server collects an application log recording a change of the client by execution a scrip code included in an operation log or the web page from the client as necessary, and a user log, such as a type of the web browser, to generate a reproduction web page and a reproduction user log for reproducing the web operation on an external reproduction device together with a content of a corresponding web page.

In this case, an operation from an original content or user log is improved and a part which becomes in reproduction on an external reproduction device is specified and a document or an application code is modified or deleted in order implement safety reproduction. Further, simultaneously, even an operation log or an application log included in an original user log is modified or deleted in order to maximally accurately reproduce a situation of a user's operation without absorbing a difference between the external reproduction device and the web browser of the client, stopping an operation of the web browser by reproduction of the operation, or transmitting incorrect data to a web server. The operation is reproduced in the external reproduction device by using the content or the user log after conversion.

Hereinafter, various embodiments of the present invention will be described in sequence with reference to the accompanying drawings. In the embodiments described below, a client, a web server, a content storage and reproduction server may be referred to as a client device, a web server device, and a content storage and reproduction server device, respectively.

### First Embodiment

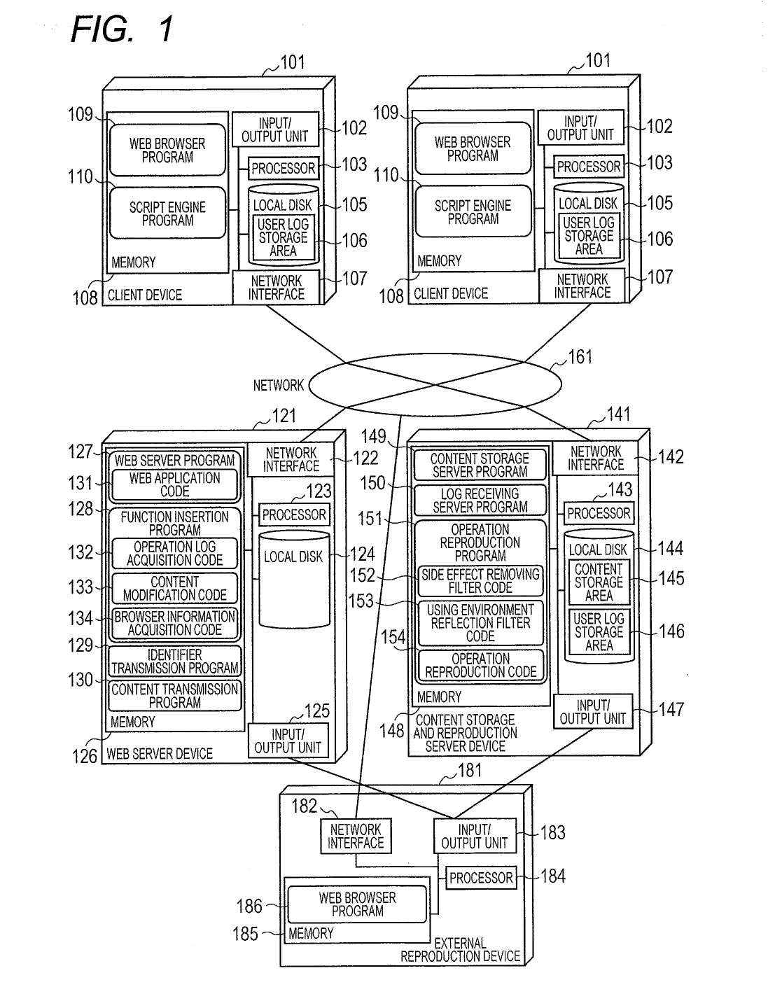

A method for reproducing a web operation on a web browser and a system therefor according to a first embodiment will be described with reference to FIGS. 1 to 5.

FIG. 1 is a system configuration diagram illustrating an example of a hardware configuration that executes a web application as a target and a software configuration of a system in the embodiment.

Hardware includes a client device 101, a web server device 121, a content storage and reproduction server device 141, an external reproduction device 181, and a network 161 connecting the devices. Further, the hardware of each device may be implemented by the same hardware or constituted by a plurality of units. The content storage and reproduction server device 141 has a function to generate reproduction data reproduced by the external reproduction device 181, but the content storage and reproduction server device 141 itself may be configured to serve as the external reproduction device 181.

The client device 101, the web server device 121, the content storage and reproduction server device 141, and the external reproduction device 181 are all computers that have processors 103, 123, 143, and 184 as processing units, memories 108, 126, 148, and 185 as storage units, input/output units 102, 125, 147, and 183, and network interfaces 107, 122, 142, and 182, and are connected with each other. The client device 101, the web server device 121, and the content storage and reproduction server device 141 also have local disks 105, 124, and 144 as the storage units. However, in some devices, some of the components may be omitted.

A web browser program 109 and a script engine program 110 are stored in the memory 108 of the client device 101. The programs are read and executed by the processor 103 as the processing unit.

The web browser program 109 serves to request a web page or receive and analyze a response of the requested web page to generate a display screen. The script engine program 110 serves to analyze a script code included in the response of the web page and execute processing written in the script code by means of the processor 103.

A keyboard, a mouse, a monitor, or the like is connected to the input/output unit 102, which is used to perform an instruction of execution or stop of the programs or display an execution result of the programs on a monitor. The processor 103 reads and processes the programs from the memory 108. The network interface 107 performs transmission and reception of the request and the response with the web server device or transmission and reception of an operation log to and from an external device of the client device 101 via the network 161.

A web server program 127, a function insertion program 128, an identifier transmission program 129, and a content transmission program 130 are stored in the memory 126 of the web server device 121. The programs may be included in each other, and for example, the identifier transmission program 129 may be included in the web server program 127. A web application code 131 is included or parallel installed in the web server program 127. An operation log acquisition code 132, a content modification code 133, and a browser information acquisition code 134 are included in the function insertion program 128. The programs are read and executed by the processor 123.

The web server program 127 serves to generate the response of the web page to make a response according to the request from the external device such as the client device 101, and the like. The function insertion program 128 serves to add or modify a content included in the response with respect to the response of the web page.

The identifier transmission program serves to generate or acquire an identifier associated with the web page generated by the web server program 127 to transmit the generated or acquired identifier to the external device. As the identifier associated with the web page, an ID having a unique value for each request of the web page or an ID that may specify a request source of the web page may be used.

The content transmission program 130 serves to transmit the content of the web page generated by the web server program 127 to the external device. The web server program 127 also serves to transmit the content of the web page to the client device of the request source, but the content transmission program 130 may transmit the content even to an external device other than the request source of the web page such as the content storage and reproduction server device 141 or the external reproduction device 181, and in this case, performs transmission in association with the identifier associated with the web page.

The input/output unit 125, the processor 123, the network interface 122 have the same functions as the devices having the same names in the client device 101. The entirety or a part of the web page is kept in the local disk 124.

A content storage server program 149, a log receiving server program 150, and an operation reproduction program 151 are stored in the memory 148 of the content storage and reproduction server device 141. The programs are read and executed by the processor 143.

The content storage server program 149 receives contents such as the web page transmitted from the client device 101 or the web server device 121 or the identifier that specifies the request source of the web page, stores them in a content storage area 145 of the local disk 144, or reads out data thereof on the content storage area 145 or the memory 148, and transmits the contents or data to the log receiving server program 150.

The log receiving server program 150 displays a list in link with the content storage server program 149 or selects a specific identifier or operation log and transmits the selected identifier or operation log to the external device. Further, an operation log associated with the specific identifier is transmitted to the external device. For example, a user log such as information on a browser is transmitted and the user log is received, as a result of an operation of the user on the web browser or execution of an application included in the web page from the client device 101. The logs are stored in a user log storage area 146 on the local disk 144, and the logs are read out as necessary.

The operation reproduction program 151 converts the content or the user log on the memory 148 or the local disk 144 in link with the content storage server program 149 and the log receiving server program 150 to reproduce the operation situation of the user in the external reproduction device 181. A side effect removing filter code 152, a using environment reflection filter code 153, and an operation reproduction code 154 are included in the operation reproduction program 151.

The side effect removing filter code 152 provides a function to unnecessarily change a state of the external reproduction device 181 with respect other devices such as the web server device 121, and the like or convert the content or the user log so as to prevent a side effect by the reproduction of the operation such as a stop of the reproduction of the operation, at the time of reproducing the operation in the external reproduction device 181. In other words, the conversion means changing data such as the content or the user log into data in which the side effect does not occur or data in which the side effect is removed. Further, the removal of the side effect means changing the data such as the content or the user log into data except for an operation of changing the state with respect other devices such as the web server device, and the like. In addition, the content or the user log which is the data in which the side effect is removed, which is acquired by the conversion, becomes a reproduction content or a reproduction user log.

The using environment reflection filter code 153 improves reproducibility of the operation or prevents the reproduction of the operation from being stopped by converting the content or the user log by considering a difference between a web browser environment of the user and a web browser environment in which the operation is reproduced in the external reproduction device 181 at the time of reproducing the operation in the external reproduction device 181.

The operation reproduction code 154 provides a function to reproduce the operation on the web page in the web browser on the external reproduction device 181 by using the content after conversion or the user log after conversion by the side effect removing filter code 152 or the using environment reflection filter code 153 according to a request from the external reproduction device 181.

The input/output unit 147, the processor 143, and the network interface 142 have the same functions as the devices having the same names in the web server device 121.

A web browser program 186 is stored in the memory 185 of the external reproduction device 181. The web browser program 186 is read and executed by the processor 184. The web browser program 186 displays the web page similarly to the web browser program 109 and the script engine program 110 of the client device 101. However, the web browser program 186 performs reproduction or pause of the operation on the web page according to the content or the user log in link with the operation reproduction program 151 of the content storage and reproduction server device 141.

The input/output unit 183, the processor 184, and the network interface 182 have the same functions as the devices having the same names in the web server device 121.

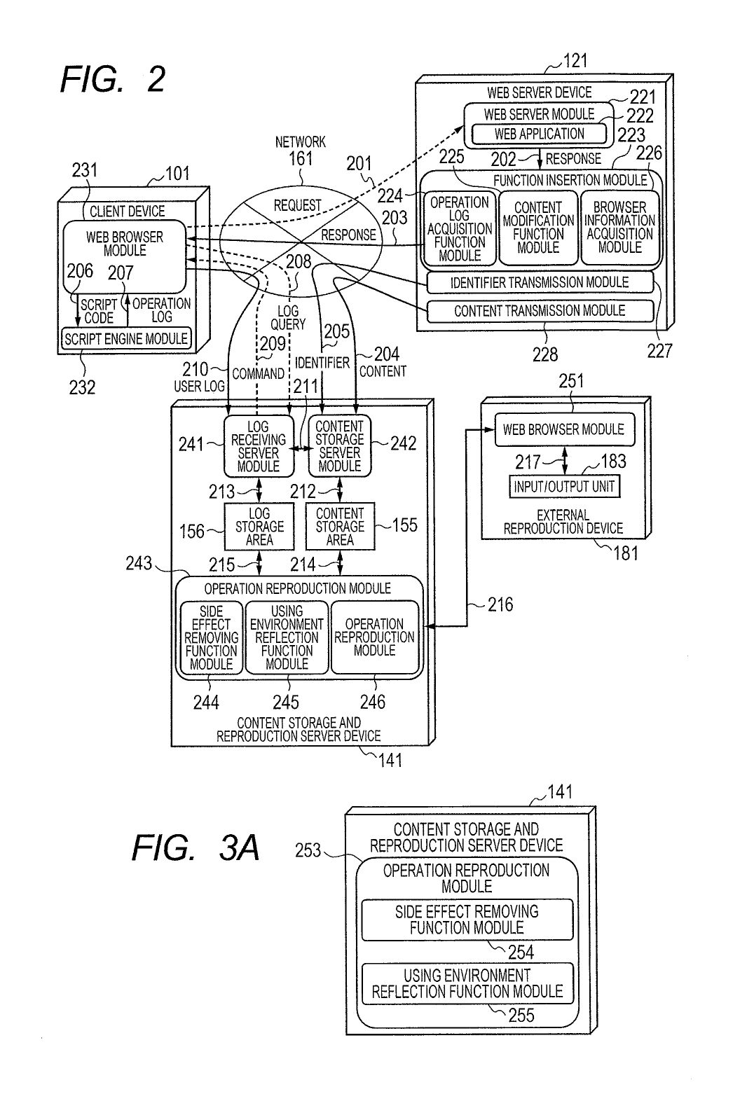

In the system configuration of the embodiment described above, a recording and reproduction processing flow of the web operation will be described with reference to FIGS. 2 to 5.

As described in FIG. 1, in a system in which the client device 101, the web server device 121, and the content storage and reproduction server device 141 are connected to each other through the network 161, the request of the web page is transmitted from the client device 101, the web server device 121 generates the response of the requested web page to make a response, the web page is displayed or the script code is executed in the client device 101, and user logs, such as the web page itself, the contents such as the identifier associated with the web page, the operation log on the web page, the execution result of the application included in the web page, the information on the browser, or the like, are accumulated in the content storage and reproduction server device 141.

Further, transmission/reception of the user log such as the operation log, and the like, or a query for controlling the log operation or exchange of a command to transfer a control content is also performed between the content storage and reproduction server device 141 and the client device 101. The external reproduction device 181 receives the content or the user log, which is converted in the content storage and reproduction server device 141, to reproduce the operation on the web page.

Hereinafter, a series of processes will be described in sequence. Further, in the figures after FIG. 2, a state in which the program is executed on the processor is referred to as a module and for example, the case where the web browser program is executed on the processor is referred to as a web browser module.

As illustrated in FIG. 2, first, a web browser module 231 of the client device 101 transmits the request of the web page to the web server device 121 via the network 161. A request 201 at least includes uniform resource identifiers (URI) that designate a place in which the web page exists. In the web server device 121, a web server module 221 receives the request, and a web application 222 that performs processing depending on the web application code 131 generates a response 202 of a requested web page.

The response 202 is transmitted to the web browser module 231 of the client device 101 via a function insertion module 223 included in the web server device 121. An operation log acquisition function module 224 of the function insertion module 223 inserts a function to acquire the operation log on the web browser module 211 into the response 202 in the form of a script code 206 executed on a script engine module 232 included in the client device 101. Further, see, for example, Japanese Patent Application Laid-Open Publication No. 2009-104267 entitled “Processing Recording Method and Processing Recording Device for Web Application” by the present inventor for the operation log acquisition function module.

A content modification function module 225 of the function insertion module 223 serves to modify some of the contents included in the response 202 and inserts an identifier associated with the response into the contents. A browser information acquisition function module 226 inserts into the response 202 a function to acquire and record information on the web browser module 211, for example, information on a type or version of the web browser, in the form of the script code 206 executed on the script engine module 212 included in the client device 101.

In the web server device 121, an identifier transmission module 227 generates or acquires an identifier 205 associated with the response 202 of the web page and transmits the generated or acquired identifier 205 to the content storage and reproduction server device 141. Further, a content transmission module 228 transmits a content 204 of the web page included in the response 202 to the content storage and reproduction server device 141. The operations thereof may be performed in sequence or in parallel simultaneously.

In the client device 101, the content included in a response 203 is displayed by using the web browser module 231, and a subsequent request is transmitted by the operation or the script code 206 included in the content is executed by using the script engine module 232. The script code inserted into the operation log acquisition function module 224 is also executed by the script engine module 232, and the operation log on the web browser module 231 or an application log, which is the execution result of the application included in the web page, is generated. The generated operation log or application log is stored on the memory 108 or the local disk 105 of the client device 101 together with the identifier.

Further, the browser information acquisition function module 226 is also executed by the script engine module 232 similarly to the operation log acquisition function module 224, and information on the web browser module 231 is stored on the memory 108 or the local disk 105 of the client device 101 as the browser information together with the identifier. Hereinafter, the operation log, the application log, and the browser information generated by the operation log acquisition function module 224 and the browser information acquisition function module 226 are combined with each other, which are referred to as the user log.

A function to query whether a transmission request of the user log or an operation request of the user log is provided to the content storage and reproduction server device 141 via the web browser module 231 is included in the operation log acquisition function module 224. In regard to the query, in the case where a command 209 is returned, the user log stored on the memory 108 or the local disk 105 is transmitted to the content storage and reproduction server device 141 or the user log is deleted, according to the command 209. Processing other than the transmission of the user log or the deletion of the user log is also included in the command 209.

In the content storage and reproduction server device 141, a content storage server module 242 receives the content 204 and the identifier 205 from the web server device 121 and stores the content 204 and the identifier 205 in the content storage area 145. Further, a log receiving server module 241 displays list data of the stored identifier 205 on the external reproduction device 181, and the like, generates a command to transmit the user log of the web page associated with the selected identifier from the client device 101, transmits the command 209 of the log transmission with respect to a log query 208 from the client device 101 to receive a user log 210 from the client device 101, and stores the user log 210 in the user log storage area 146, in association with the content storage server module. As described above, a command to execute processing other than the log transmission is included in the command 209. An operation reproduction module 246 provides a function to reproduce the web operation to the external reproduction device 181 by using the content or the user log which is converted by the content storage and reproduction server device 141.

In the external reproduction device 181, a web browser module 251 communicates with the content storage and reproduction server device 141, displays a list of the identifiers stored in the content storage and reproduction server device 141, selects a specific identifier by an input from the input/output unit 183, and notifies the selected identifier to the content storage and reproduction server device 141 or displays an operation state on the web page or changes the display state according to an instruction from the input/output unit 183, via the operation reproduction module 246 of the content storage and reproduction server device 141. In FIG. 2, the external reproduction device 181 and the content storage and reproduction server device 141 are directly connected to each other, but may be connected to each other via the network 161 and further, may receive the content or the user log from other devices such as the web server device 121, and the like.

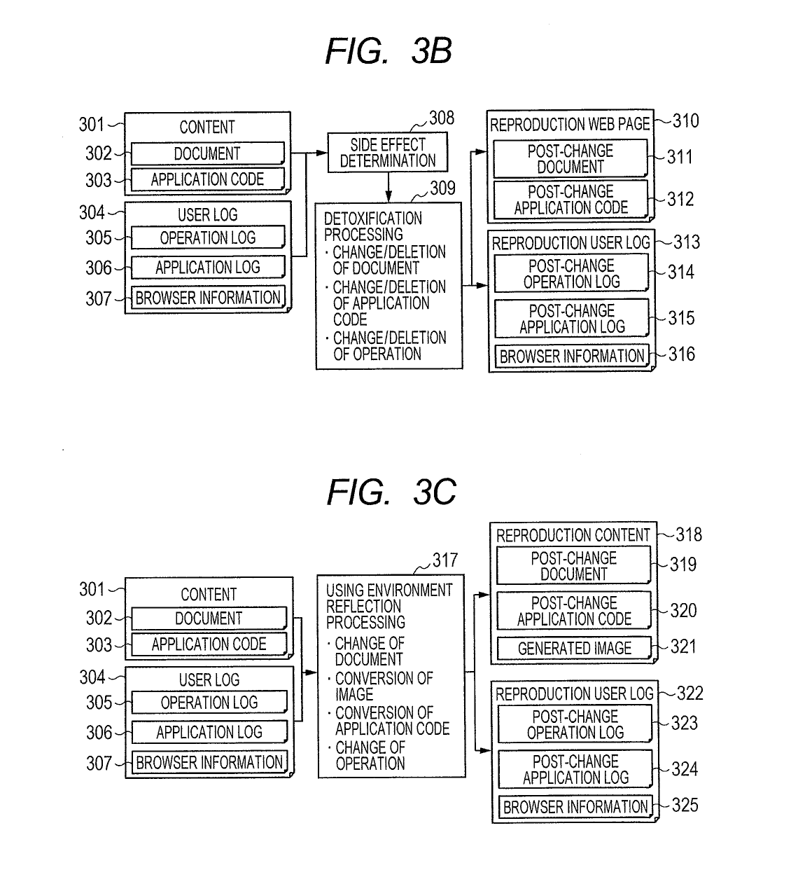

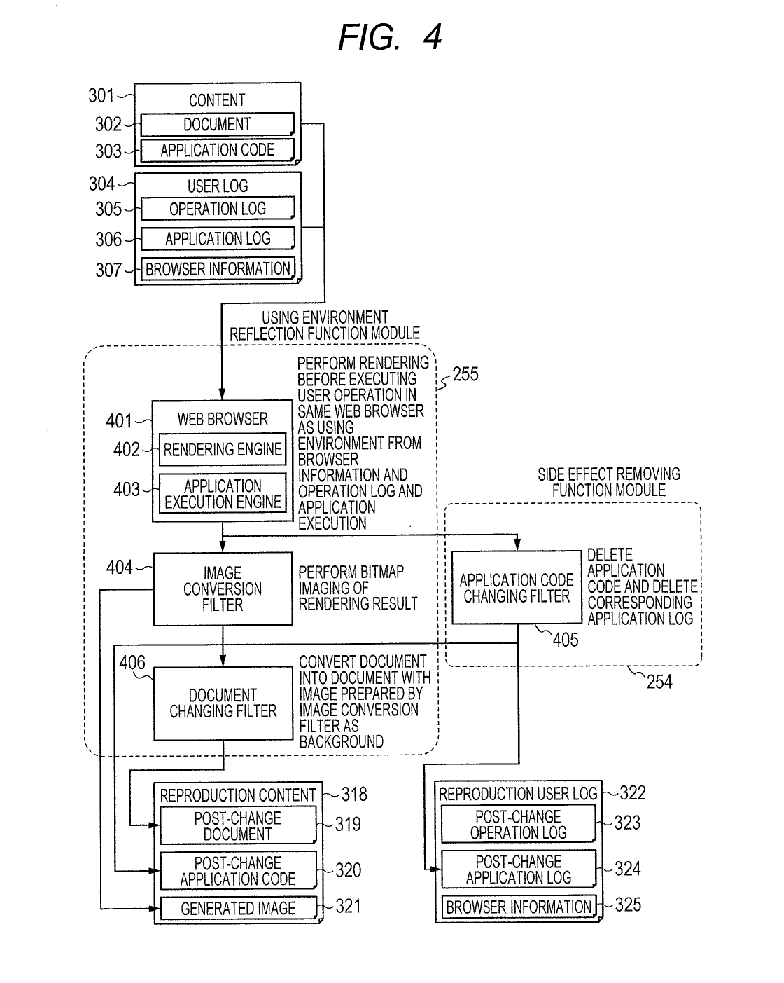

Subsequently, a processing flow of a method for recording and reproducing a web operation in a first embodiment will be described with reference to FIGS. 3 to 5. FIGS. 3A, 3B, and 3C are diagrams illustrating a processing flow of converting a content and a user log, and FIG. 4 is a diagram illustrating an example of conversion processing.

In FIG. 3A, a side effect removing function module 254 and a using environment reflection function module 255, which are included in the operation reproduction module 253 of the content storage and reproduction server device 141, are extracted and FIGS. 3B and 3C schematically illustrate functions of respective functional modules, respectively. Parts, which are not illustrated in FIG. 3A, are the same as those illustrated in a flowchart of recording and reproducing the web operation of FIG. 2.

First, both the side effects of removing function module 254 and the using environment reflection function module 255 serve to generate reproduction contents 310 and 313 and reproduction user logs 318 and 322 by converting a content 301 and a user log 304. A document 302 such as an HTML document, and the like and an application code 303 such as a JavaScript code (Java is a registered trademark), and the like are included in the content 301. An operation log 305 of recording the operation of the user on the web browser, an application log 306 of recording the execution result of the application code included in the web page, and browser information 307, which is the information on the web browser of the user, are included in the user log 304. Further, although not illustrated in FIG. 3, the content storage and reproduction server device 141 holds even information on the web browser module 251 of the external reproduction device 181.

As illustrated in FIG. 3B, the side effect removing function module 254 first determines the side effect which occurs at the time of reproducing the web operation in the external reproduction device 181 from the content 301 and the user log 304 and thereafter, performs detoxification processing 309 of the side effect, and generates the reproduction content 310 and a reproduction user log 314. The side effect means a case in which an operation, which should not originally occur, occurs at the time of reproducing the web operation, and may be an operation in which a request of rewriting data is transmitted to the content storage and reproduction server device 141 from the web browser that reproduces an operation, for example, at the time of reproducing a mouse clock operation on the web page. Another example of the side effect may be an operation in which the application code included in the content is operated, a different value (for example, time and date) from a value in the operation of the user is displayed on the web page, or the operation of the web browser stops, while reproduction of the web operation is being executed on the web browser of the external reproduction device 181.

In the case of the determination of the side effect, the determination may be just performed from a fact that a code to cause the side effect in the application code 303 is present, but in this case, it is determined that even a code, which is not actually operated, causes a side effect or it is difficult to determine a case in which the side effect occurs according to a condition. Therefore, the side effect such as whether the code is an operating application code, whether the side effect occurs at that time, whether the side effect occurs by the operation of the user, and the like, is determined by using the document 302 or the user log 304 to improve precision of the determination, improve precision of the reproduction, or decrease an occurrence possibility of the side effect in the reproduction. Herein, the determination method of the side effect is described by using the application code 303 as an example, but the side effect is determined by combining the respective contents or user logs similarly even with respect to the document 302, the operation log 305, the application log 306, or the like.

Subsequently, in the detoxification processing 309 of FIG. 3B, conversion of deleting a corresponding part or changing the content or the user log in which the side effect does not occur is performed with respect to the content or the user log in which the side effect is determined to occur at the time of reproducing the web operation by side effect determination 308. For example, in the case where a specific button on the web page is clicked, a specific application code is operated, and as a result, in the case where a communication of changing the state of the content storage and reproduction server device 141 occurs, examples of the method of the detoxification processing 309 include a method of deleting the specific button from the document, a method of deleting the operation log to record the clicking operation of the specific button, a method of changing the operation log to an operation log to just display a fact that the clicking operation is performed without actually performing the clicking operation in reproduction, a method of deleting a corresponding specific application code, a method of changing the corresponding specific application code to an application code in which a communication to change a state of the content storage and reproduction server device 141 does not occur, or the like. They are examples, and the detoxification processing 309 is performed by selecting and combining methods such as change and deletion of the document, change and deletion of the application code, change and deletion of the operation, and the like.

Subsequently, using environment reflection processing 317 will be described with reference to FIG. 3C. In the using environment reflection processing 317, first, when the web operation is reproduced in the external reproduction device 181 from the content 301 and the user log 304, the reproduction content 318 and the reproduction user log 322 are generated by converting the content 301 and the user log 304 to prevent the precision of the reproduction from deteriorating by a difference of an environment of the web operation of the user and a reproduction environment of the web operation in the external reproduction device 181. Conversion in the using environment reflection processing 317 is performed by the using environment reflection processing 317 and for example, in the case where the size of an object included in a document displayed by a difference of the web browser is different, the web browser of the user and the web browser in reproduction are the same as each other in size of the object by changing the document. Other examples thereof include a method of executing rendering equivalent to the web browser of the user, converting the execution result into an image, and setting the converted image as a background of the document, a method of changing a part in which a technology of the application is different for each web browser, or a method of changing a part in which an event type generated by the web operation is different for each web browser.

A generation image 321 is generated in the reproduction content 318 generated by the using environment reflection function module 255. Further, they are examples, and the using environment reflection processing 317 is performed by selecting and combining methods such as the change of the document, the change of the application code, the change of the operation, the generation of the image, and the like.

FIG. 4 illustrates one example of a processing flow of converting a content and a user log in the content storage and reproduction server device 141 described in FIG. 3A. In this example, by assuming a case in which the web browser of the user and the web browser of the reproduction environment of the external reproduction device 181 are significantly different, a processing content in the case where the content 301 and the user log 304 are converted by using the content storage and reproduction server device 141 will be described. First, in the embodiment, a web browser is prepared, which renders to the using environment reflection function module 255 the same web page as the environment of the user from the browser information 307 of the user log 304, and the content 301 pm the web browser is rendered before executing the user operation.

Subsequently, in an image converting filter 404, a rendering result is, for example, bitmap-imaged. Thereafter, in a document changing filter 406, a background of the document 302 included in the content 301 is changed into a bitmap image generated in the image converting filter 404. In parallel with them, in the side effect removing function module 254, the application code 303 included in the content 301 and the application log 306 included in the user log 304 are deleted after rendering the web page in the side effect removing function module 254.

The above conversion result is generated as the reproduction content 318 and the reproduction user log 322 and the web operation is reproduced in the external reproduction device 181 by using the generated conversion result. By this configuration, even in the case where the web browser of the user and the web browser of the reproduction environment are significantly different from each other, the web operation in which the side effect does not occur may be reproduced with high precision.

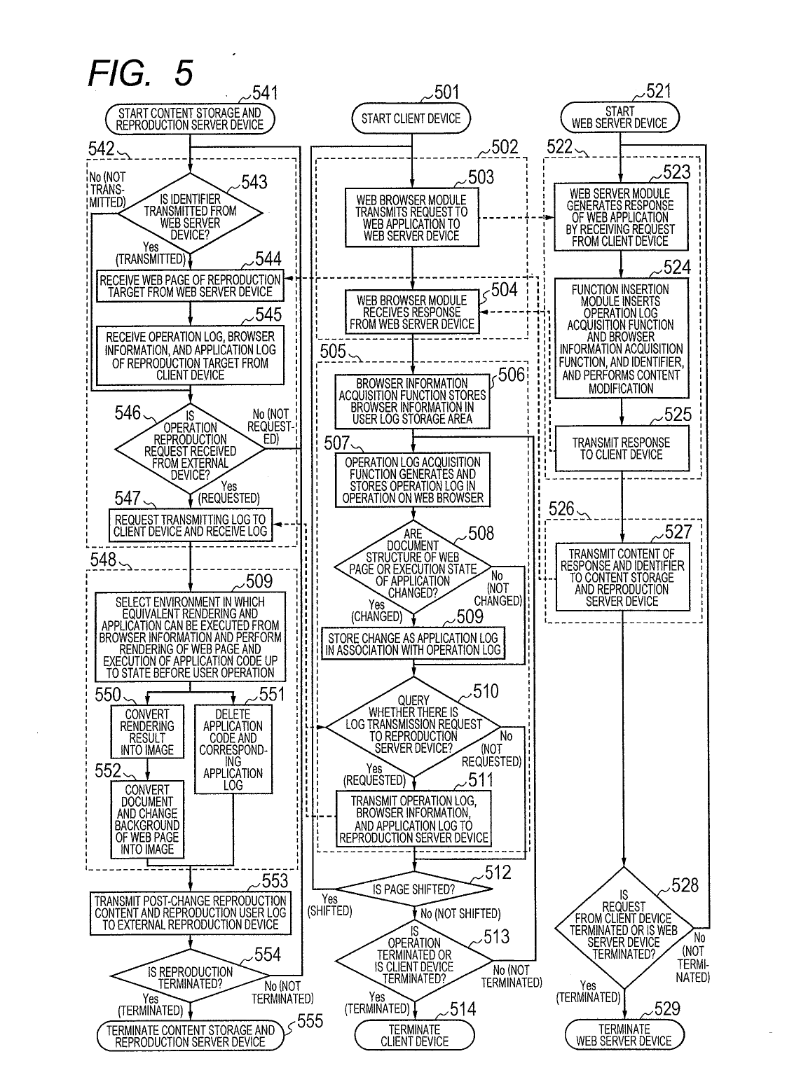

Subsequently, the processing flow of recording and reproducing the web operation including the conversion of the content 301 and the user log 304 described in up to FIG. 4 will be collectively described with reference to FIG. 5. First, a web browser module of a client device transmits a request to a web application, to a web server device (step S503). In the web server device, a web server module receives the request from the client device to generate a response of the web application (step S523). Further, a function insertion module inserts an operation log acquisition function and a browser information acquisition function, and an identifier which is a unique value whenever the response is generated, into the response (step S524). The identifier is the unique value for each response, and is used to specify a content of a web page of the response, an operation log of an operation which is performed on the web page, a document structure associated with the operation log, and the like. Subsequently, the response is transmitted to the client device (step S525). Continuously, a content transmission module and an identifier transmission module transmit a content including the response and the identifier to a content storage and reproduction server device (step S527).

Steps S523 to S527 may be executed in parallel simultaneously without being limited to a sequence illustrated in FIG. 5. The web server device terminates processing when the request from the client device is terminated or the web server device is terminated (steps S528 and S29).

Continuously, the client device receives the response from the web server device (step S504). A series of processes of steps S503 and S504 in the client device are a flow of processing of displaying the web page in the client device, and hereinafter, the processes are collectively called step S502.

The content storage and reproduction server device determines whether the identifier is transmitted from the web server device (step S543) and when the identifier is transmitted, the content storage and reproduction server device receives and stores the identifier and the content (step S544). Continuously, the content storage and reproduction server device verifies whether a request for operation reproduction from an external reproduction device is made (step S545) and when the request for the operation reproduction is made, the content storage and reproduction server device requests transmitting a log to the client device together with the identifier of a reproduction target (step S546). When the request for the operation reproduction is not made, the process returns to step S543. Continuously, user logs such as an operation log of an operation reproduction target, browser information, an application log, and the like are received from the client device (step S547). Hereinafter, communication processes with the web server device of steps S543 to S547 are collectively called step S542.

A process continued in step S542 is executed in an operation reproduction module 243 and includes various processes, but herein, one example will be exemplified.

In the content storage and reproduction server device 141, an environment in which rendering of the web page on the client device from the browser information received from the client device 101, rendering equivalent to execution of the application code, and execution of the application code are possible is selected and prepared, rendering of the web page up to a state before an operation of a user, and the execution of the application code are performed (step S549). Continuously, a rendering result is converted into an image (step S550), and further, a document of the web page is converted to set the image generated in step S550 as a background image of the web page (step S552). Further, in parallel with steps S550 and S552, the application code included in the web page and a corresponding application log included in the user log are deleted (step S551). Hereinafter, the processes of steps S549 to S552 are collectively called step S548.

By step S548, when the web operation is reproduced in the external reproduction device, the web operation may be reproduced with high precision and further, the content and the web operation may be converted into a content and a user log that are capable of suppressing a side effect such as causing a communication of changing a state of the web server device at the time of reproducing the web operation, regardless of a difference between an operation environment of the web page of the client device and a reproduction environment of the web page of the external reproduction device. Last, the reproduction content and the reproduction user log after conversion are transmitted to the external reproduction device (step S553). It is determined whether the reproduction of the operation is terminated (step S554) and when the reproduction of the operation is not terminated, the process returns to step S543 and otherwise, the process is terminated (step S555).

Further, although the external reproduction device is not illustrated in FIG. 5, the external reproduction device transmits a request for the reproduction of the operation to the content storage and reproduction server device and receives the reproduction content and the reproduction user log generated in the content storage and reproduction server device to reproduce the operation, as disclosed in the processing flow of the content storage and reproduction server device.

In the client device 101 in which displaying the web page is completed, a browser information acquisition function stores information on the web browser in a user log storage area as the browser information (step S506). Subsequently, an operation log acquisition function generates an operation log in operation on the web browser and stores the generated operation log in the user log storage area (step S507). Herein, it is determined whether a state is changed by execution of the application code included in the document structure of the web page or the web page (step S508) and when the state is changed, conversion is stored in the user log storage area as an application log in association with the operation log (step S509). When the state is not changed, step S509 is skipped. Thereafter, it is queried to the content storage and reproduction server device whether a request for transmitting the log is made (step S510).

In this case, the client device or an identifier, which may specify the displayed web page, is transmitted to a log link server device. When the transmission request is made, the user logs such as the operation log, the browser information, the application log, and the like are transmitted to the content storage and reproduction server device (step S511). When the transmission request is not made, step S511 is skipped. Thereafter, it is verified whether a page is shifted (step S512), and when the page is shifted, the process returns to step S503 and when the page is not shifted, it is determined whether the operation is terminated or the client device is terminated (step S513), and when the operation or the client device is not terminated, the process returns to step S507 and other processes are terminated (step S514).

### Second Embodiment

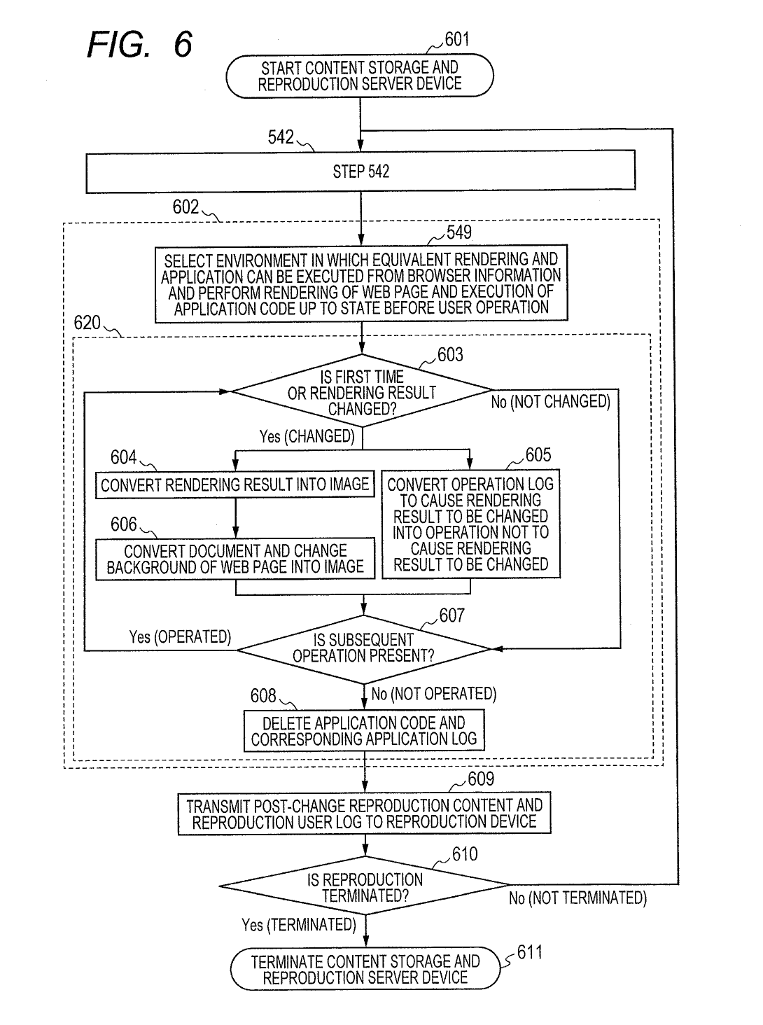

Continuously, a second embodiment will be described with reference to FIG. 6. Herein, only a difference from the first embodiment will be described and the parts described in the first embodiment will be omitted.

FIG. 6 is a processing flowchart illustrating a second embodiment regarding conversion of a content and a user log. Processing other than the content storage and reproduction server device 141 is omitted, but is the same as a processing flow illustrated in FIG. 5.

The difference from the first embodiment is that, in the first embodiment, since only an initial state of the rendering result of the web page before the user operation is converted into the image to be used as the background of the document, in the case where the rendering result is changed by the user operation, the change may not be reproduced, but in the second embodiment, even the change of the rendering result by the user operation may be reproduced with high precision.

In step S542 of FIG. 6, while the content from the server device and the user log from the client device are provided, an environment in which rendering of the web page on the client device from the browser information received from the client device, rendering equivalent to execution of the application code, and execution of the application code are possible is selected and prepared, the rendering of the web page up to a state before an operation of a user, and the execution of the application code are performed (step S549).

Continuously, it is determined whether the image conversion of the rendering result is not yet performed or the rendering result is changed (step S603), and when the image conversion is not performed or the rendering result is changed, the rendering result is converted into the image (step S604) and further, the image generated in step S604 is set as the background image of the web page by converting the document of the web page (step S606). Further, in parallel with steps S604 and S606, an operation log of an operation which causes the rendering result to be changed is converted into an operation that does not cause the rendering result to be changed (step S605).

As an example of step S605, in the case where a character string displayed on the web page is changed by a clicking operation for a button on the web page, a method may be used, which converts an operation log of a corresponding click into an operation log that just displays the clicking operation on the web page without actually performing the clicking operation at the time of reproducing the web operation.

Further, in the determination by step S603, in the case where the image conversion of the rendering result is not yet performed, that is, in the case of initial processing, step S605 may be skipped. Continuously, it is determined whether the operation log is provided (step S607), and when the operation log is provided, the process returns step S603 and when the operation log is not provided, an application code included in the web page and a corresponding application log included in the user log are deleted (step S608). Last, the reproduction content and the reproduction user log after conversion are transmitted to the external reproduction device (step S609). It is determined whether the reproduction of the operation is terminated (step S610) and when the reproduction of the operation is not terminated, the process returns to step S542 and otherwise, the process is terminated (step S611).

By a processing flow of the second embodiment described above, even the change of the rendering result by the user operation may be reproduced with high precision.

### Third Embodiment

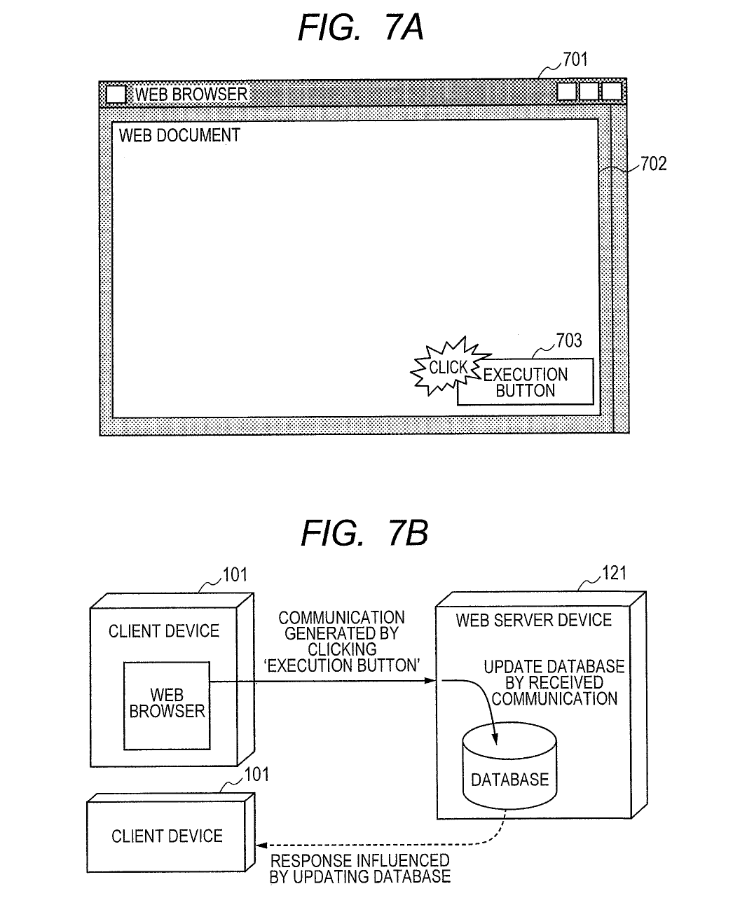

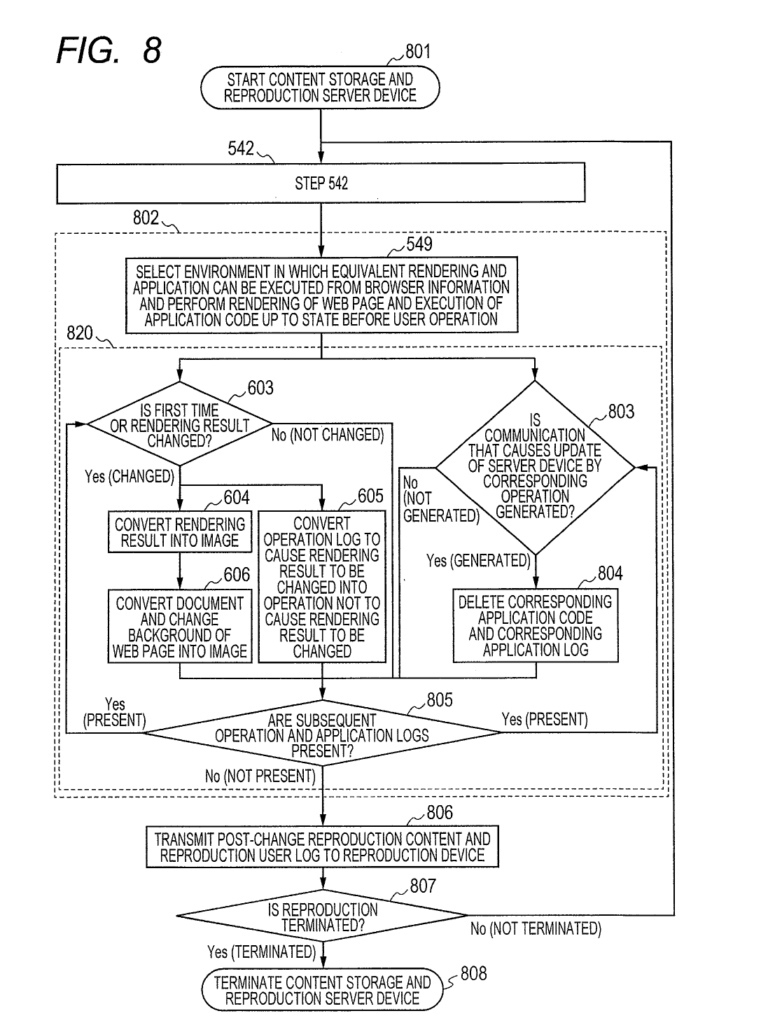

A third embodiment will be described with reference to FIGS. 7A, 7B, and 8. Herein, only a difference from the first and second embodiments will be described and the parts described in the first and second embodiments will be omitted.

FIGS. 7A and 7B are diagrams illustrating examples in which a problem occurs at the time of reproducing an operation. FIG. 8 is a processing flowchart of the third embodiment associated with conversion of a content and a user log, which addresses the problems illustrated in FIGS. 7A and 7B. Processing other than the content storage and reproduction server device is omitted, but is the same as a processing flow illustrated in FIG. 5.

As illustrated in FIG. 7A, an execution button 703 is included in a web document 702 displayed on a web browser 701 and a state in which the execution button 703 is clicked is schematically illustrated. Herein, a communication occurs with respect to a web server device by clicking the execution button on a displayed web page, which includes an application code having a function to update a state of a web server.

As a result, as schematically illustrated in FIG. 7B, a communication occurs with respect to a web server device 121 from a web browser of a client device 101 by clicking the execution button, and as a result, in the web server device 121, a state stored in the web server device 121 such as a database included in the web server device 121, and the like is updated, for example, by the received communication. In the case where the web operation is reproduced, when the execution button 703 is clicked as it is, the state of the web server device is updated even in reproducing the web operation and thereafter, in the case where the web page is requested with respect to the web server device from another client device 101, a response to another client device 101 is generated in a state different from an original state of the web server device by updating the state of the web server device, and as a result, an influence occurs.

In the embodiment, another processing flow associated with the content and the user log illustrated in FIG. 8, which addresses the problems, is executed. A difference from the first and second embodiments is that precision of the reproduction of the web operation may deteriorate by deleting even an application code in which the problems illustrated in FIGS. 7A and 7B do not occur even though the application code included in the web page is deleted in the first and second embodiments. Therefore, the third embodiment describes a method of reproducing the web operation with high precision by selectively deleting the application code in which the problem occurs.

In step S542, while the content from the server device and the user log from the client device are provided, an environment in which rendering of the web page on the client device from the browser information received from the client device, rendering equivalent to execution of the application code, and execution of the application code are possible is selected and prepared, the rendering of the web page up to a state before an operation of a user, and the execution of the application code are performed (step S549). Continuously, it is determined whether the image conversion of the rendering result is not yet performed or the rendering result is changed (step S603), and when the image conversion is not performed or the rendering result is changed, the rendering result is converted into the image (step S604) and further, the image generated in step S604 is set as the background image of the web page by converting the document of the web page (step S606). Further, in parallel with steps S604 and S606, an operation log of an operation which causes the rendering result to be changed is converted into an operation that does not cause the rendering result to be changed (step S605). Steps S603 to S606 are the same as those of the second embodiment.

In parallel with steps S603 to S606, it is determined whether a communication causing the server state to be updated occurs by an operation which a reproduction target from the operation log and the application log (step S803) and when the communication occurs, a corresponding application code and a corresponding application log are deleted (step S804). Continuously, it is determined whether the operation log or the application log is provided (step S805) and when the operation log or the application log is provided, the process returns to steps S603 and S803 and when the operation log or the application log are not provided, a reproduction content and a reproduction user log after conversion are transmitted to an external reproduction device (step S806). It is determined whether the reproduction of the operation is terminated (step S807) and when the reproduction of the operation is not terminated, the process returns to step S542 and otherwise, the process is terminated (step S808).

As described above, even in the case where the application code included in the web page is operated, the web operation may be reproduced with high precision, by the processing flow of the third embodiment.

### Fourth Embodiment

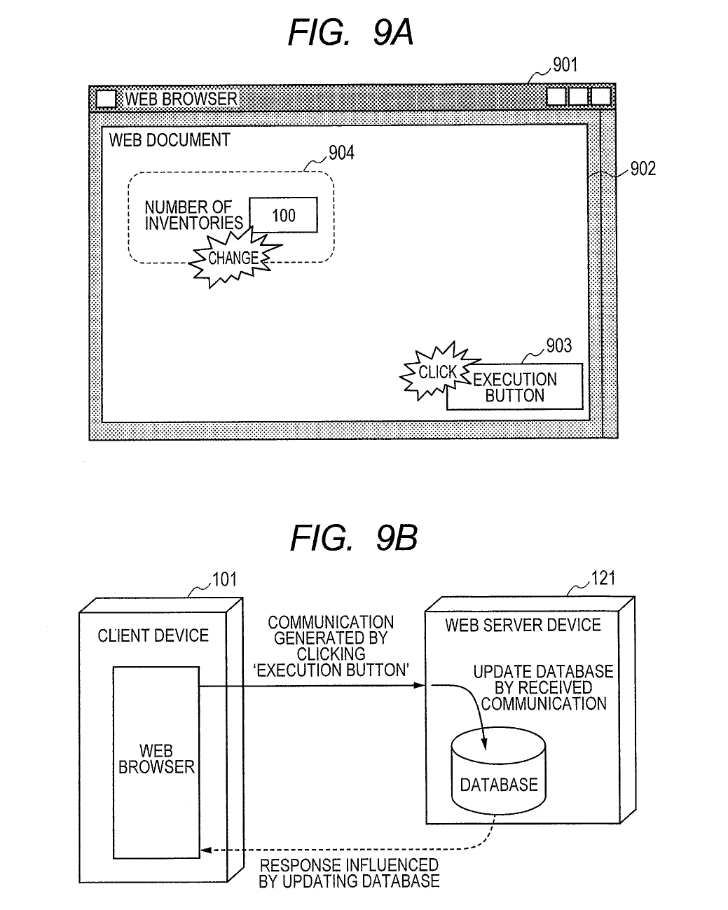

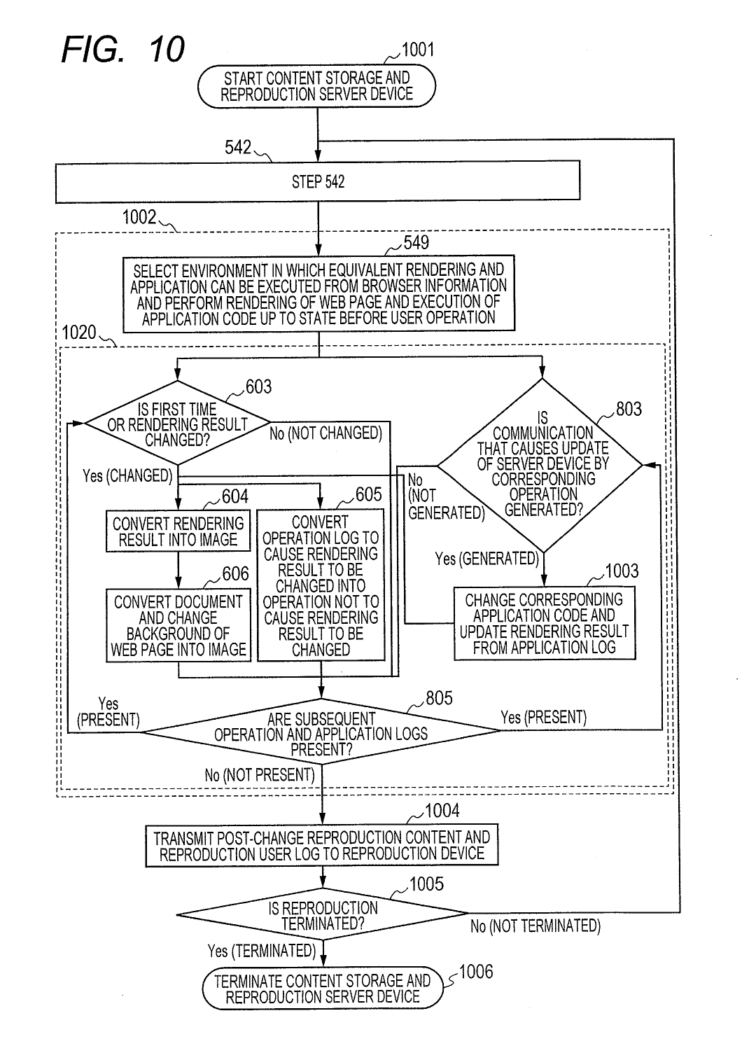

A fourth embodiment will be described with reference to FIGS. 9 and 10. Herein, only a difference from the first, second, and third embodiments will be described and the parts described in the first, second, and third embodiments will be omitted.

FIGS. 9A and 9B are diagrams illustrating examples in which a problem occurs at the time of reproducing an operation. FIG. 10 is a processing flowchart of the fourth embodiment associated with conversion of a content and a user log, which solves the problems illustrated in FIGS. 9A and 9B. Processing other than the content storage and reproduction server device 141 is omitted, but is the same as a processing flow illustrated in FIG. 5.

FIG. 9A schematically illustrates a state in which an execution button 903 and text information 904 are included in a web document 902 displayed on a web browser 901 and the execution button 903 is clicked to update the text information 904. Herein, a communication occurs with respect to a web server device by clicking the execution button on a displayed web page, which includes an application code having a function to update a state of a web server and further, update the text information by a response from a web server.

As a result, as illustrated in FIG. 9B, a communication occurs with respect to a web server device 121 from a web browser of a client device 101 by clicking the execution button, and as a result, in the web server device 121, a state stored in the web server device such as a database included in the web server device, and the like is updated, for example, by the received communication. Further, a response is generated with respect to the client device with a change in the state of the web server device and the text information displayed on the client device is updated by the response.

In the case where the web operation is reproduced, when the execution button is clicked as it is, as described in the third embodiment, the state of the web server device is updated even in reproducing the web operation and thereafter, in the case where the web page is requested with respect to the web server device 121 from another client device 101, a response to another client device 101 is generated in a state different from an original state of the web server device by updating the state of the web server device, and as a result, an influence occurs. Meanwhile, in the case where the state of the web server device is not updated or the communication does not occur, a problem in which the text information is not accurately updated occurs.

Therefore, in the embodiment, another processing flow associated with conversion of the content and the user log illustrated in FIG. 10, which addresses the problems, is executed. A difference from the first, second, and third embodiments is that precision of the reproduction of the web operation may deteriorate only by deleting an application code in the problem as illustrated in FIG. 9 even though the application code included in the web page in which the problem occurs is deleted in the first, second, and third embodiments. Therefore, the fourth embodiment discloses a method of reproducing the web operation with high precision by the changing of the application code and thereafter, execution of rendering, by changing the application code in which the problem occurs.

In step S542, while the content from the content storage and reproduction server device 141 and the user log from the client device 101 are provided, an environment in which rendering of the web page on the client device from the browser information received from the client device, rendering equivalent to execution of the application code, and execution of the application code are possible is selected and prepared, the rendering of the web page up to a state before an operation of a user, and the execution of the application code are performed (step S549).

Continuously, it is determined whether the image conversion of the rendering result is not yet performed or the rendering result is changed (step S603), and when the image conversion is not performed or the rendering result is changed, the rendering result is converted into the image (step S604) and further, the image generated in step S604 is set as the background image of the web page by converting the document of the web page (step S606). Further, in parallel with steps S604 and S606, an operation log of an operation which causes the rendering result to be changed is converted into an operation which does not cause the rendering result not to be changed (step S605). Steps S603 to S606 are the same as those of the second embodiment.

In parallel with steps S603 to S606, it is determined whether a communication causing the server state to be updated occurs by an operation which a reproduction target from the operation log and the application log (step S803) and when the communication occurs, rendering is performed by changing a corresponding application code (step S1003). An example of the change of the application code includes a method of changing an application code, which makes the communication occur and receives the response to the communication, to an application code that makes the response be received without performing an actual communication by acquiring a reception result of the response from the application log without making the communication occur.

As a result, the text information 904 of FIG. 9A is immediately updated. In addition, the process proceeds to steps S604 and S605 in order to convert a rendering result into an image. Subsequent to the above processing, it is determined whether the operation log or the application log is provided (step S805) and when the operation log or the application log is provided, the process returns to steps S603 and S803 and when the operation log or the application log are not provided, a reproduction content and a reproduction user log after conversion are transmitted to an external reproduction device (step S1004). It is determined whether the reproduction of the operation is terminated (step S1005) and when the reproduction of the operation is not terminated, the process returns to step S542 and otherwise, the process is terminated (step S1006).

Even in the case where the application code included in the web page is operated and the rendering result of the web page is changed, the web operation may be reproduced with high precision, by the aforementioned processing flow of the fourth embodiment.

### Fifth Embodiment

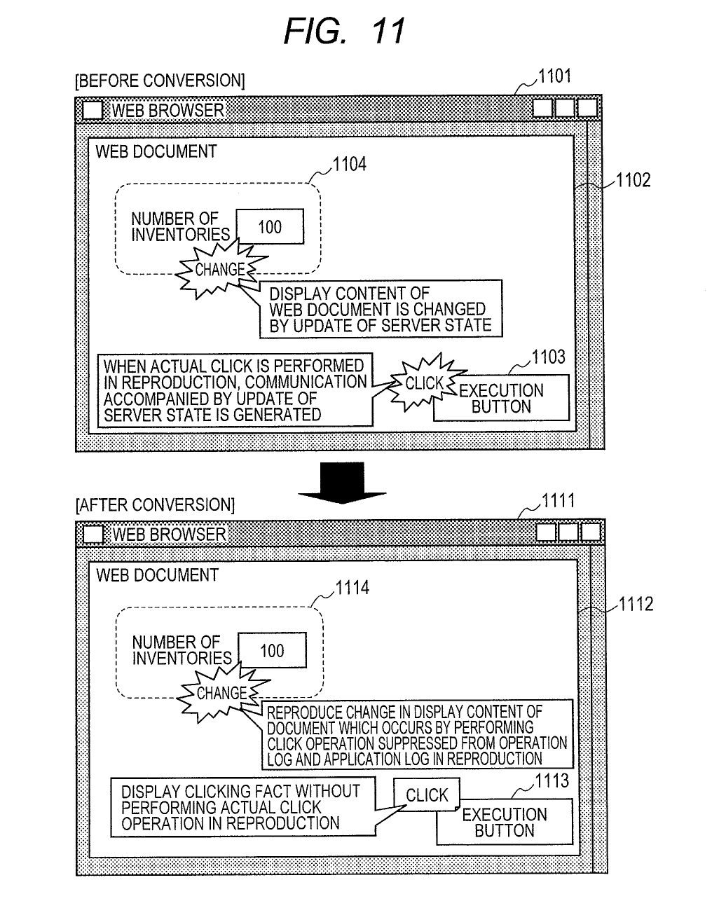

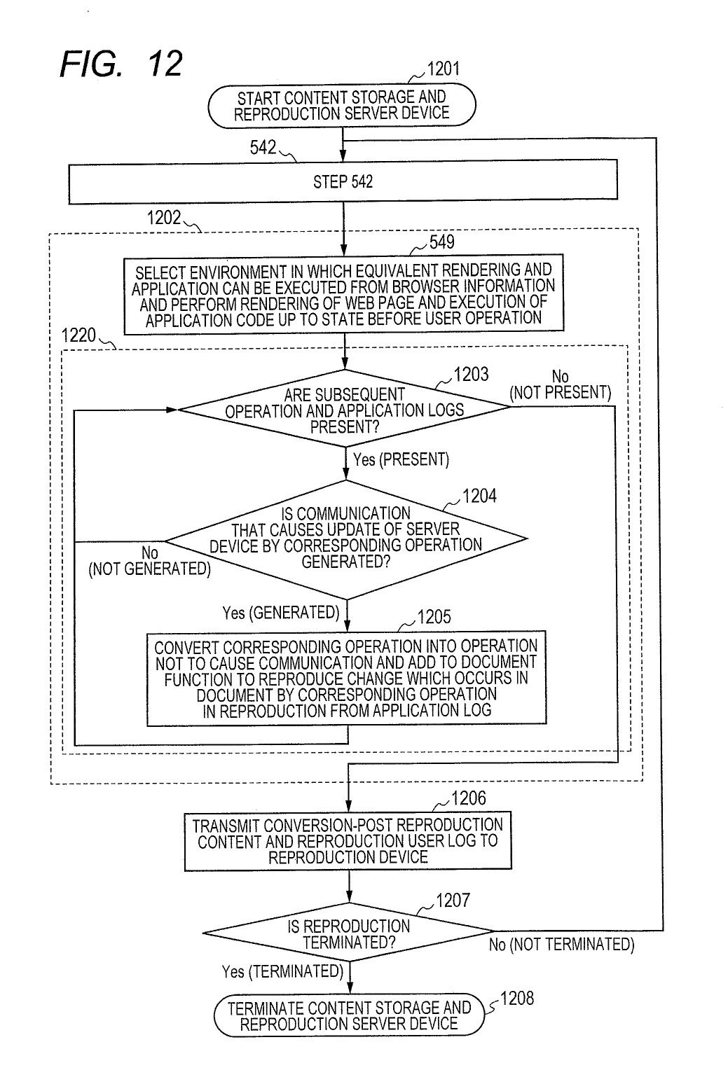

A fifth embodiment will be described with reference to FIGS. 11 and 12. Herein, only a difference from the first, second, third, and fourth embodiments will be described and the parts described in the first, second, third, and fourth embodiments will be omitted.

FIG. 11 is a diagram illustrating an example in which a problem occurs at the time of reproducing an operation. FIG. 12 is a processing flowchart of another embodiment associated with conversion of a content and a user log, which addresses the problem illustrated in FIG. 11. Processing other than the content storage and reproduction server device is omitted, but is the same as a processing flow illustrated in FIG. 5.

FIG. 11 schematically illustrates a state in which an execution button 1103, 1113 and text information 1104, 1114 are included in a web document 1102, 1112 displayed on a web browser 1101, 1111 and the execution button 1103, 1113 is clicked to update the text information 1104, 1114. The upper web browser 1101 of FIG. 11 illustrates a state before the conversion of the content and the user log and the lower web browser 1111 of FIG. 11 illustrates a state after the conversion of the content and the user log. The reproduction states of the operations before and after the conversion are substantially the same as each other, but only reproductions of the operation of the execution button 1103, 1113 of one location before and after the conversions, are different from each other.

Before the conversion, the execution button 1103 is actually clicked, and as a result, the application code is executed and the communication that updates the state of the web server occurs. In addition, a display content of the text information 1104 is updated as the state of the web server is updated. Meanwhile, after the conversion, for example, the state stored in the web server device, such as the database included in the web server device, and the like, is updated by the occurrence of the communication that updates the state of the web server, and when the request of the web page is performed to the web server device 121 from another client device 101, a fact of a clicking operation is just displayed as illustrated in FIG. 11 without actually performing the clicking operation in order to suppress a problem in which the response to another client device 101 is generated in a state different from the original state of the web server device by the update of the state of the web server device, and as a result, an influence occurs.

However, when the clicking operation is not actually performed, the application code executed by the clicking operation is not executed, and as a result, a problem in which the text information 1114 is not updated occurs. In regard to this problem, in the embodiment, the web operation is reproduced with high precision by updating the text information 1114 by using the operation log and the application log.

A processing flow of the fifth embodiment associated with conversion of the content and the user log illustrated in FIG. 12, which addresses the problem will be described. A difference from the first, second, third, and fourth embodiments is that the web operation is reproduced without deleting or changing the application code even though the application code included in the web page in which the problem occurs is deleted or changed in the first, second, third, and fourth embodiments.

In step S542, while the content from the server device and the user log from the client device are provided, an environment in which rendering of the web page on the client device from the browser information received from the client device, rendering equivalent to execution of the application code, and execution of the application code are possible is selected and prepared, the rendering of the web page up to a state before an operation of a user, and the execution of the application code are performed (step S549). Thereafter, it is determined whether a subsequent operation or application log is provided (step S1203), and when the subsequent operation or application log is provided, it is determined whether a communication, which causes the state of the server to be updated by a corresponding operation, occurs (step S1204). When the communication occurs, the corresponding operation is converted into an operation not to cause communication and a function to reproduce a change, which occurs in a document by the corresponding operation in reproduction from the application log, is add to a document (step S1205).

A detailed example include a method in which, in the case where the function to cause the communication is included in the application code executed by the operation or the communication occurs in the application log associated with the operation, in other words, an execution state of the application code that influences the state of the web server is recorded as the application log, the operation corresponding to the application code recorded in the corresponding application log is not actually executed but changed to an operation to display only the fact of the operation on the web browser and a display content of the web page, which is changed by the operation, is acquired from the application log to change the document. When the operation or the application log, which is the reproduction target of the web operation, is not provided, the reproduction content and the reproduction user log after conversion are transmitted to the external reproduction device (step S1206). It is determined whether the reproduction of the operation is terminated (step S1207) and when the reproduction of the operation is not terminated, the process returns to step S542 and otherwise, the process is terminated (step S1208).

Even in the case where the application code is operated by the operation and the rendering result of the web page is changed, the web operation may be reproduced with high precision without deleting or changing the application code, by the aforementioned processing flow of the fifth embodiment.

### Sixth Embodiment

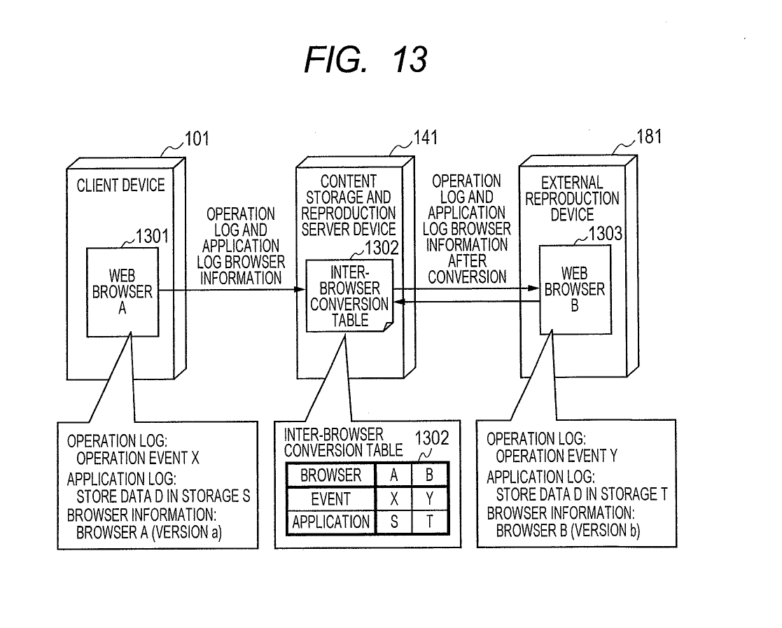

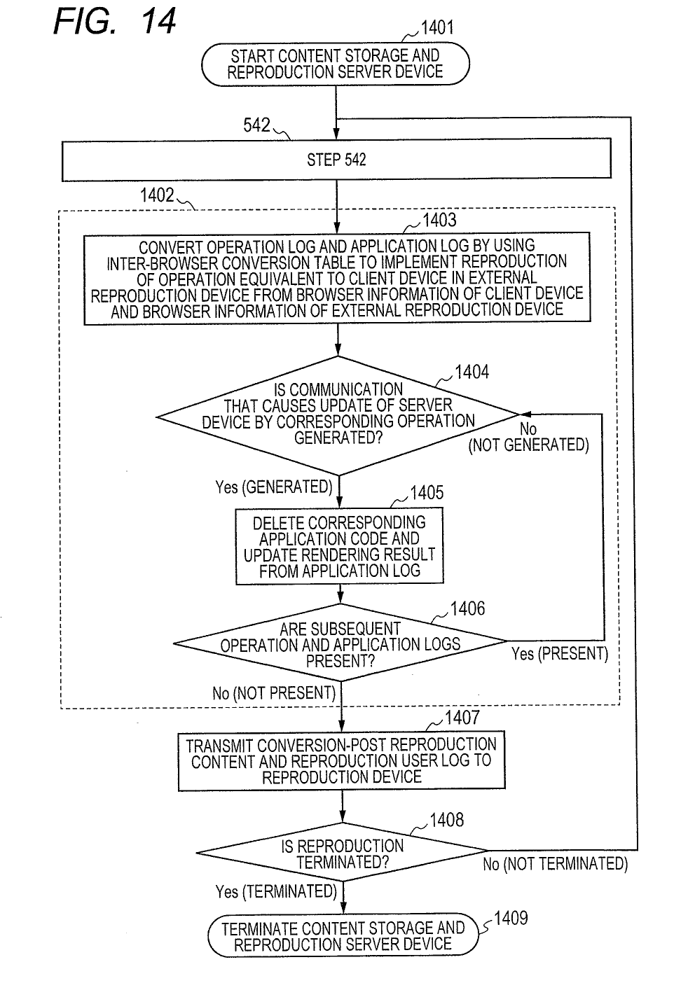

A sixth embodiment will be described with reference to FIGS. 13 and 14. Herein, only a difference from the first, second, third, fourth, and fifth embodiments will be described and the parts described in the first, second, third, fourth, and fifth embodiments will be omitted.

FIG. 13 is a diagram schematically illustrating a method of reproducing a web operation with high precision by conversion of a content or a user log when web browsers of a client device 101 and an external reproduction device 181 are different from each other. FIG. 14 is a processing flowchart of another embodiment associated with the conversion of the content and user log illustrated in FIG. 13. Processing other than the content storage and reproduction server device is omitted, but is the same as a processing flow illustrated in FIG. 5.

The method of the sixth embodiment illustrated in FIG. 13 is a method in which in the case where a web browser A 1301, which a user operates on the client device 101, and a web browser B 1303, which reproduces the web operation on the external reproduction device 181, are different from each other, an inter-browser conversion table 1302, which discloses a conversion method of the content or the user log, is prepared in order to absorb the difference between the browsers in a content storage and reproduction server device 141 and the web operation is reproduced by converting the content or the user log in the inter-browser conversion table 1302 to perform high-precision reproduction of the web operation.

In detail, in the case where an operation event X on the web browser A corresponds to an operation event Y on the web browser B, a correspondence relationship thereof is disclosed in a table format, in the inter-browser conversion table 1302. Even in regard to the application log, in the case where a storage name of a storage place of data is a storage S on the web browser A and a storage T on a web browser B, a correspondence relationship thereof is disclosed in the inter-browser conversion table 1302. In FIG. 13, only the operation log and the application log are illustrated, but all included in the content or the user log, such as a document, an application code, and the like, are targets that are described in the inter-browser conversion table 1302.

The processing flow of the sixth embodiment illustrated in FIG. 13 will be described with reference to FIG. 14. A difference from the first, second, third, fourth, and fifth embodiments is that the operation is reproduced with high precision by performing rendering by providing the environment in which equivalent rendering and the application are executable in the content storage and reproduction server device, from the browser information of the client device 101, in the first, second, third, fourth, and fifth embodiments, but the web operation is reproduced without preparing the environment of rendering and execution of the application in the sixth embodiment.

In step S542 of FIG. 14, while the content from the server device and the user log from the client device are provided, the content or the user log is converted by using the inter-browser conversion table so as to reproduce an operation equivalent to the client device in the external reproduction device, from the browser information of the client device and the browser information of the external reproduction device (step S1403). Thereafter, it is determined whether the communication that causes the server state to be updated occurs by the operation (step S1404) and when the communication occurs, the corresponding application code and the corresponding application log are deleted (step S1405) and when the communication does not occur, step S1405 is skipped. The process is continued while a subsequent operation or application log is provided (step S1406) and thereafter, the reproduction content and the reproduction user log after conversion are transmitted to the external reproduction device (step S1407). It is determined whether the reproduction of the operation is terminated (step S1408) and when the reproduction of the operation is not terminated, the process returns to step S542 and otherwise, the process is terminated (step S1409).

By the aforementioned processing flow, the web operation may be reproduced with high precision by converting the content or the user log without preparing an environment of rendering equivalent to the web browser of the client device and execution of the application.

### Seventh Embodiment

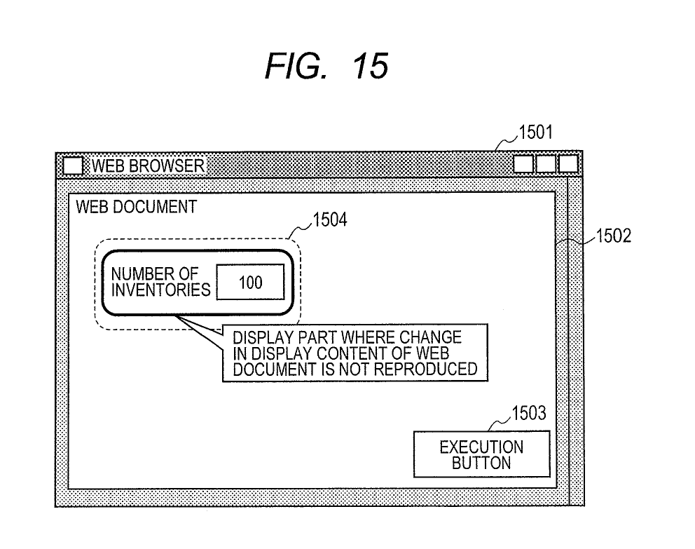

Continuously, a seventh embodiment will be described with reference to FIG. 15.

FIG. 15 is a diagram schematically illustrating a state in which a web document 1502 including an object, such as an execution button 1503 or text information 1504, is displayed on a web browser 1501. As illustrated in the first to sixth embodiments, when the side effect is suppressed at the time of reproducing the web operation, a complete operation may not be reproduced and a part different from the content at the time of recording the operation may be present in the display content of the web page. For example, by the deletion of the application code, the display content is updated by executing the application code in recording, but the application code may not be executed and the display content may not be updated in reproduction. Therefore, a part where the display contents in recording and reproduction of the operation are different from each other or a part where there is a possibility that the difference will occur is displayed on the web browser 1501. As a result, a reproduction situation of the web operation may implement correct analysis.

As described above, the first to seventh embodiments (1 to 7) of the present invention have been described. The present invention is not limited to the embodiments and includes various modified examples such as combinations thereof, and the like. Some of components of a predetermined embodiment may be substituted by components of another embodiment and further, components of another embodiment may be added to components of a predetermined embodiment. Further, other components may be added, deleted, and substituted with respect to some of the components of each embodiment.

Further, the actual first to seventh embodiments just illustrate examples and for example, a case in which the operation is recorded while the operation is reproduced is also implemented by combining the embodiments of the present invention. Further, information which may be included in the content and the user log may include all information which is recordable on the web browser. In addition, although the number of all of the devices is one, the number of the devices may be multiple or a plurality of devices may be combined with a small number of devices.

Further, some or all of respective components, functions, processing units, processing means, and the like of the embodiments may be implemented by, for example, hardware. In addition, information of a program that implements each component, each function, and the like, a table, a file, and the like may be stored in recording devices such as a solid state drive (SSD), and the like, or a recording media such as an IC card, an SD card, a DVD, and the like, in addition to the illustrated memory or local disk and may be downloaded or installed via the network, and the like as necessary.

### REFERENCE SIGNS LIST

101 Client device
102, 125, 147, 183 Input/output unit
103, 123, 143, 184 Processor
105, 124, 144 Local disk
107, 122, 142, 182 Network interface
108, 126, 148, 185 Memory
109, 186 Web browser program
110 Script engine program
121 Web server device
127 Web server program
128 Function insertion program
129 Identifier transmission program
141 Content storage and reproduction server device
145 Content storage area
146 User log storage area
149 Content storage server program
150 Log receiving server program
151 Operation reproduction program
161 Network
181 External reproduction device
186 Display program
701, 901, 1101, 1501 Web browser window

1. A method for recording and reproducing a web operation in a system constituted by a web server, a web browser displaying a web page, a content storage and reproduction server collecting and storing contents of the web page, and a network coupling them to each other, wherein:
inserting, by the web server, an operation log acquisition function and a browser information acquisition function into the web page and transmits the inserted functions and transmits the contents to the content storage and reproduction server, at the time of transmitting a generated web page to the web browser,
executing, by the web browser, the browser information acquisition function in the received web page, acquires and records information on the web browser, executes the operation log acquisition function, generates and records an application log of a result of executing an operation log on the web page and an application code include in the web page, and transmits the information on the web browser, the operation log, and the application log to the content storage and reproduction server as a user log, and
generating, by the content storage and reproduction server, a reproduction content and a reproduction user log for reproducing an operation on a web browser of a reproduction device by converting the collected content and user log.

2. The method for recording and reproducing a web operation according to claim 1,
wherein the content storage and reproduction server records the information on the web browser at the time of recording the operation log, prepares an environment in which rendering equivalent to rendering in recording and execution of the application code are possible, based on the information on the web browser, uses a result of performing rendering and execution of the application code in the corresponding environment, and generates the reproduction content and the reproduction user log.

3. The method for recording and reproducing a web operation according to claim 2,
wherein the content storage and reproduction server includes image data generated from the rendering result in the reproduction content and reproduces the web operation by using the image data.

4. The method for recording and reproducing a web operation according to claim 3,
wherein the content storage and reproduction server extracts a change of the rendering result and generates the image data and makes the generated data be included in the reproduction content from the rendering result when the rendering result is changed.

5. The method for recording and reproducing a web operation according to claim 1,
wherein the content storage and reproduction server extracts an application code that influences a state of the web server at the time of reproducing the operation from the content and the user log, deletes or annuls the extracted application code or converts the extracted application code into an application code which does not influence the state of the web server, and makes the converted application code into the reproduction content, and reproduces the web operation by using the application code after the conversion.

6. The method for recording and reproducing a web operation according to claim 5,
wherein an execution state of an application code, which influences the state of the web server, is recorded in the application log at the time of recording the operation log.

7. The method for recording and reproducing a web operation according to claim 1,
wherein the content storage and reproduction server extracts an operation log that influences a state of the web server at the time of reproducing the operation from the content and the user log, deletes or annuls the extracted operation log or converts the extracted operation log into an operation log which does not influence the state of the web server, and makes the converted operation log into the reproduction user log, and reproduces the web operation by using the operation log after the conversion.

8. The method for recording and reproducing a web operation according to claim 7,
wherein an execution result of an operation which influences the state of the web server is recorded in the application log at the time of recording the operation log.

9. The method for recording and reproducing a web operation according to claim 1,
wherein the content storage and reproduction server includes the information on the web browser recorded at the time of recording the operation log, information on a web browser of the external reproduction device, and a conversion table of a content and a user log corresponding to a combination of the web browser and the web browser of the external reproduction device, and reproduces the web operation by converting the content and the user log by using the conversion table.

10. The method for recording and reproducing a web operation according to claim 1,
wherein the content storage and reproduction server converts the content and the user log into the reproduction content and the reproduction user log and displays a part where a display content on the web browser at the time of reproducing the operation and a display content at the time of recording the operation are different from each other or there is a possibility that the display contents will be different from each other in the display content on the web browser at the time of reproducing the operation to reproduce the web operation.

11. A device for reproducing a web operation that reproduces a web page generated by a web server and displayed by a web browser, the device comprising:
a processing unit; and
a storage unit,
wherein the storage unit stores a content of the web page displayed in the web browser, information on the web browser which the web browser acquires and records by executing a browser information acquisition function, which is collected from the web browser, and a user log constituted by an operation log on the web page which the web browser acquires and records by executing an operation log acquisition function, and an application log of a result of executing an application code included in the web page, and
the processing unit generates a reproduction content and a reproduction user log for reproducing an operation on a web browser of an external reproduction device by converting the content and the user log stored in the storage unit.

12. The device for reproducing a web operation according to claim 11,
wherein the processing unit prepares an environment in which rendering equivalent to rendering in recording and execution of the application code are possible, uses a result of performing rendering and execution of the application code in the corresponding environment, and generates the reproduction content and the reproduction user log, based on the information on the web browser at the time of recording the operation log.

13. The device for reproducing a web operation according to claim 12,
wherein the processing unit includes image data generated from the rendering result in the reproduction content and reproduces the web operation by using the image data.

14. The device for reproducing a web operation according to claim 13,
wherein the processing unit extracts a change of the rendering result and generates the image data and makes the generated data be included in the reproduction content from the rendering result when the rendering result is changed.

15. The device for reproducing a web operation according to claim 11,
wherein the processing unit extracts an application code that influences a state of the web server at the time of reproducing the operation from the content and the user log, deletes or annuls the extracted application code or converts the extracted application code into an application code which does not influence the state of the web server, and makes the converted application code into the reproduction content, and reproduces the web operation by using the application code after the conversion.

16. The device for reproducing a web operation according to claim 15,
wherein an execution state of an application code which influences the state of the web server is recorded in the application log at the time of recording the operation log.

17. The device for reproducing a web operation according to claim 11,
wherein the processing unit extracts an operation log that influences a state of the web server at the time of reproducing the operation from the content and the user log, deletes or annuls the extracted operation log or converts the extracted operation log into an operation log which does not influence the state of the web server, and makes the converted operation log into the reproduction user log, and reproduces the web operation by using the operation log after the conversion.

18. The device for reproducing a web operation according to claim 17,
wherein an execution result of an operation which influences the state of the web server is recorded in the application log at the time of recording the operation log.

19. The device for reproducing a web operation according to claim 11,
wherein the storage unit includes the information on the web browser recorded at the time of recording the operation log, information on a web browser of the external reproduction device, and a conversion table of a content and a user log corresponding to a combination of the web browser and the web browser of the external reproduction device, and the processing unit reproduces the web operation by converting the content and the user log by using the conversion table.

20. The device for reproducing a web operation according to claim 11,
wherein the processing unit converts the content and the user log into the reproduction content and the reproduction user log and displays a part where a display content on the web browser at the time of reproducing the operation and a display content at the time of recording the operation are different from each other or there is a possibility that the display contents will be different from each other in the display content on the web browser at the time of reproducing the operation to reproduce the web operation.
